(19) United States
(12) Patent Application Publication
(10) Pub. No.: US 2014/0038145 A1
(43) Pub. Date: Feb. 6, 2014

(54) ADDICTION CESSATION DEVICE AND RELATED METHOD

(71) Applicant: Charles Eric Wolfrey, Montvale, NJ (US)

(72) Inventor: Charles Eric Wolfrey, Montvale, NJ (US)

(21) Appl. No.: 13/954,539

(22) Filed: Jul. 30, 2013

Related U.S. Application Data
(60) Provisional application No. 61/677,553, filed on Jul. 31, 2012.

(51) Int. Cl. G09B 19/00

(52) U.S. Cl. CPC G09B 19/00
USPC 434/236

(57) ABSTRACT

The current invention discloses an addiction cessation device and related methods to assist a user to quit an addiction to a substance. To achieve this goal, the current invention exposes the user to negative signals whenever the urges to consume the substance arise. The addiction cessation device may be a flat surface having a back side and a front side, where the flat surface is folded so that the back side forms at least one cover page to conceal the front side, and where the front side comprises words and images that cause negative reactions to the addiction and the words and images on the front side can be revealed by unfolding the flat surface. The current invention helps the quitting efforts by revealing and displaying the images and words on the addiction cessation device to the user and providing information to associate the negative feelings created by the images or words with the addiction. By repeatedly revealing the images and words of the device when in urge of the addiction, the user may develop an association of negative reaction with the addictive substance. Additional mechanisms may involve releasing an odor that also creates negative reactions from the user. The current invention may be used to treat various kinds of addiction, such as smoking, alcohol abuse, and food addiction.

### CLAIM OF PRIORITY

This application claims priority of U.S. provisional application 61/677,553 which was filed on Jul. 31, 2012 and which is incorporated herein by reference in its entirety.

### FIELD OF THE INVENTION

The current invention covers devices and related methods to help addiction cessation. In particular, the current invention relates to devices and methods to use such devices to assist a person's efforts to cease the addictions such as substance abuse.

### BACKGROUND OF THE INVENTION

Substance abuse and addictions are, sadly, noticeably prevalent in the modern world. Activities such as alcohol abuse, smoking, and drug use are widespread and cause extensive damages to people's health and the economy. Take smoking as an example, it is one of the most harmful behaviors to human health and it has been identified as a major contributing factor to a series of diseases, including but not limited to various kinds of cancer, cardiovascular conditions, bronchitis, pneumonia; asthma, and emphysema. Estimations from the Center for Disease and Control (CDC) put cigarette-smoking related deaths in the US at about 440,000 per year. Alcoholism, similarly, can be devastative to a person' health and security. Alcohol abuse has been connected to countless traffic accidents and many kinds of diseases such as depression and cardiovascular arrest. In addition to the harm to human health, substance abuse and addiction also causes enormous economic loss. For example, according to the CDC's estimate, cigarette smoking was responsible for $193 billion in annual health-related economic losses during 2000-2004 in the United States.

The current invention aims to reduce the severe damages by curbing substance abuse and addiction. By repeatedly showing devices having images and words that create negative reactions related to the addiction, the current invention helps to develop a sense of repulsion to the addiction and aids in the efforts to quit. The stimulating materials in the devices may be different each time and the user may have significant freedom to adjust the contents of such materials, making the cessation attempts more likely to succeed.

### DESCRIPTION OF RELATED ART

U.S. Pat. No. 5,759,042 discloses a method involving the application of two labels containing respective positive and negative messages to a container having an addictive substance therewithin to empower and inspire fear of the addictive substance and to encourage the substance abuser from further substance abuse. The labels may be applied by the substance abuser or by individuals associated with the substance abuser to containers of the addictive substance in the abuser's possession. Upon each use of the addictive substance, positive and negative messages are conveyed to the user to assist the user in gradually eliminating their dependence on the addictive substance.

Canadian Patent CA 2,243,136 discloses a container for a cigarette pack provided with a plurality of stimuli to encourage cessation of smoking. The container has a back, bottom, sides and a front. The front is hinged to one of the sides and opens like a door. The container has means for retaining the cigarette pack within the container when the front is in an open position. The container has a plurality of stimuli-providing means for providing stimuli when the front is in the open position. The stimuli-providing means are selected from i) display means on the inside face of the front for displaying a picture, ii) smell-release means, iii) sound-making means, iv) taste-release means, v) tactile sensory means and vi) a second visual display means other than display means (i). Examples of stimuli-providing means are recorded messages, “scratch and sniff panels, salt licks, electrical shock discharge means, Braille messages, locks of hair and the like.

In summary, various methods are known in the art, but they are distinctively different from the current invention. Moreover, the other inventions fail to address all of the problems solved by the invention described herein. One embodiment of this invention is illustrated in the accompanying drawings and will be described in more detail herein below.

### SUMMARY OF THE INVENTION

The current invention discloses an addiction cessation device and related methods to assist quitting an addiction. An addiction cessation device to assist quitting an addiction is disclosed where the device comprises a flat surface having a back side and a front side, said flat surface being folded so that the back side forms at least one cover page to conceal the front side, and wherein the front side comprises words and images that cause negative reactions to the addiction and the words and images on the front side can be revealed by unfolding the flat surface.

According to one preferred embodiment the device is a trifold. According to another preferred embodiment the device is folded into two parts.

According to one preferred embodiment the device may comprise a first page having a first page inner side and a first page outer side, and a second page having a second page inner side and second page outer side, wherein the first page and second page are linked, the first page inner side bears images or words that cause negative reactions to the addiction, and the second page inner side bears images or words that cause negative reactions to the addiction. The device may also include a passage that reminds the user of the association between the negative reactions and the addiction. The related method of the current invention may comprise retrieving an addiction cessation device each time the user has an urge to consume the substance; displaying images and words on the addiction cessation device to the user to create negative reactions to the addiction to the substance, and developing an association between the negative reactions and the addiction.

Here, “addiction” is defined broadly and it may refer to the state of being compulsively associated with a substance, a habit, or practice that is psychologically or physically habit-forming. In particular, the devices and methods disclosed in the current invention are preferably used in aiding the efforts to quit the addiction to substance abuse, including but not limited to smoking, alcohol abuse, food addiction, cocaine addiction, opioid abuse, and abuse of other drugs, chemicals, and substances. One particular goal for the current invention is to assist quitting smoking.

The addiction cessation device may have various structures. The device may be a two-page note as indicated above. The two-page format discussed is one of the preferred forms. A trifold format is another preferred embodiment. Further embodiments may be a smartphone application or a tabloid application. The addiction cessation device may also be one-page or multiple-page. For the two-page version, in particular, the first page may have a first linking end permanently attached to a second linking end of the second page, and the first page and second page may overlap to conceal the images and words on the inner sides. Lifting the first page from the second page displays the images and words. In addition, the first page may have a first connecting end removably attached to a second connecting end of the second page, attaching the first connecting end to the second connecting end conceals the first page inner side and second page inner side, and detaching the first connecting end from the second connecting end displays the first page inner side and second page inner side. The basic goal is the same for other formats, the images and words are preferably concealed when the device is not in use and are displayed when the user has the urge of consuming the substance.

The device may be made of paper, cardboard, or plastic or any other feasible material where the images and words can be presented.

The addiction cessation device may also include for example olfactory elements. According to one preferred element the inner side of the device includes one or more adhesive strips impregnated with micro burst oil bubbles that are releasing a smell upon opening the device. Typically the smell would be a smell that is related to the addiction, for example smell of cigarette smoke.

Alternatively, the addiction cessation device may be structures other than notes. For example, the addiction cessation device may be a mobile computing apparatus such as a smart phone or a tablet PC that bears images and/or words that create negative reactions in the user. Such devices do not require constant replacement and may incorporate large numbers of stimulating factors—images and/or words—relatively easily.

The key effect of the addiction cessation device is that the images and/or words on the device would create negative reactions in the person viewing the device. “Negative reactions” here are broadly defined, including but not limited to: repulsion, revulsion, disgust, loath, hate, nausea, queasiness, fear, and wariness. Getting exposure to images and words that create such negative reaction reduces the likelihood that user will return to the substance. By repetitive exposure to stimulating factors such as the negative images and words and odor, the user may develop an association between the negative reactions and the addiction; helping the efforts to cure the addiction.

The images and words may be chosen from a wide variety of materials and may be tailored to a specific addiction. For example, to quit smoking, the images may include pictures of tissues from lung cancer, throat cancer, mouth cancer, or other diseases that may result from smoking. Alternatively, the images may be symbolic figures such as a tombstone. In general, the materials may vary with the key goal of creating the negative reactions in the user. The words here may include descriptions of the images in the device, warnings that the particular substance abuse may cause serious health risks, reminders that the substance abuse may shorten the user's life, and statistics regarding the harm of the substance abuse. Similarly, the materials for the words may vary, but the key purpose is to produce negative reactions.

In addition to the images and words, the addiction cessation device may further include stimulating factors such as an odor release mechanism, wherein the odor releasing mechanism is capable of releasing an odor or smell that create negative reaction to the addiction. The odor releasing mechanism may be triggered by detaching the connecting ends of the first page from the second page or by unfolding the trifold. Moreover, the pages of the addiction cessation device may include taste stimulating points where the user may lick to experience a taste that also creates negative reactions to the addiction.

In addition to the images and words and other stimulating factors that create negative reactions, the device may also comprise a passage that reminds the user to associate the negative reactions to the addiction. For example, the passage may urge the user to associate the various senses during the substance abuse—see, hear, smell, taste, and feel—with the stimulating factors (images, words, and odor) in the device, as well as with the negative reactions.

The method disclosed in the current invention is closely associated with the device indicated above. The user of the device is consistently exposed to the contents of the device whenever the urge to indulge the addiction arises. The user may open the device, reveal the images and words, trigger the odor releasing mechanism, and get exposed to all the stimulating factors that may generate negative reactions to the addiction. Persistent exposures like this will gradually dissociate the substance abuse from pleasure and associate it with the negative reactions, making the quitting efforts more likely to succeed.

In general, the present invention succeeds in conferring the following, and others not mentioned, desirable and useful benefits and objectives.

It is an object of the present invention to provide an addiction cessation device that may assist a user's efforts to quit substance abuse.

It is an object of the present invention to provide an addiction cessation device that may assist a user's efforts to quit smoking.

It is an object of the present invention to provide an addiction cessation device that includes images and words creating negative reactions in a user regarding the addiction.

It is an object of the present invention to provide an addiction cessation device that includes olfactory elements releasing smells related to the addiction upon opening the device.

It is an object of the present invention to provide an addiction cessation device that associates addiction with negative reactions.

It is an object of the present invention to provide an addiction cessation device that may release an odor creating negative reactions to the addition.

It is another object of the current invention to provide a method to assist the efforts to quit substance abuse using an addiction cessation device.

It is another object of the current invention to provide an addiction cessation method that associates the addiction with negative reactions.

It is still another object of the current invention to provide an addiction cessation device that is portable and easy to carry around.

It is another object of the current invention to provide an addiction cessation device that is inexpensive

It is yet another object of the current invention to provide an addiction cessation method that assists a person to quit an addiction without chemical intervention.

It is another object of the current invention to provide an addiction cessation method that does not require an immediate termination.

It is yet another object of the current invention to provide an addiction cessation method that allows a long term and gradual cessation.

It is yet another object of the current invention to provide an addiction cessation device that is easy to use and easy to manufacture.

### BRIEF DESCRIPTION OF THE DRAWINGS

FIG. 1 shows a front perspective view of a two page embodiment of an addiction cessation device in a closed form.

FIG. 2 shows a perspective view of the two page embodiment of an addiction cessation device in an open form.

FIG. 3 shows a back perspective view of the two page embodiment of an addiction cessation device in a closed form.

FIG. 4 shows an addiction cessation method in a flow chart.

FIG. 5 shows a back perspective view of a trifold embodiment of an addition cessation device.

FIG. 6 shows a view of an unfolded trifold embodiment of an addiction cessation device.

FIG. 7 shows a view of an opened trifold embodiment of an addiction cessation device.

FIGS. 8A, B and C shows different views of a smart phone application of an addiction cessation device.

### DESCRIPTION OF THE PREFERRED EMBODIMENTS

The preferred embodiments of the present invention will now be described with reference to the drawings. Identical elements in the various figures are identified, as far as possible, with the same reference numerals. Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention. The embodiment here is designed for quit smoking. However, it should be noted that with minor changes the device and method may be used to assist other addiction cessation efforts.

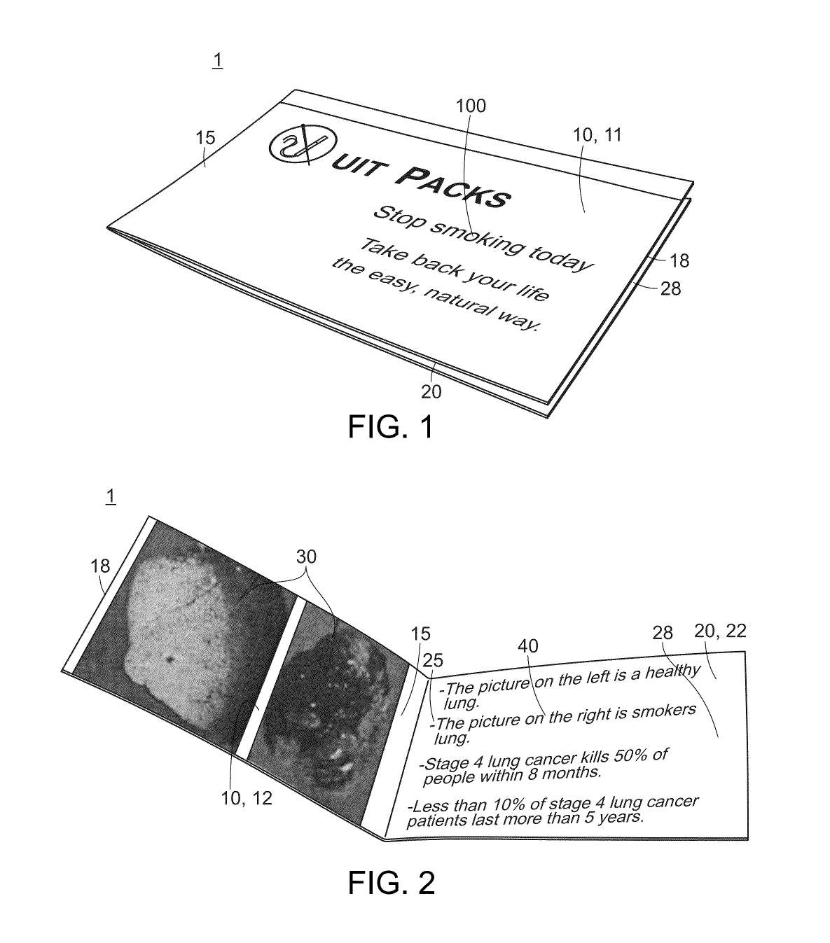

FIG. 1 shows a front perspective view of one embodiment of an addiction cessation device in a closed form. Shown in FIG. 1 is the addiction cessation device 1 having a first page 10 and a second page 20. The two pages overlap and are folded together, which defines the closed form. The first page 10 has a first page outer side 11, a first page inner side 12 (not shown in FIG. 1), a first linking end 15, and a first connecting end 18. The second page 20 has a second page outer side 21 (not shown in FIG. 1), a second page inner side 22 (not shown in FIG. 1), a second linking end 25 (not shown in FIG. 1), and a second connecting end 28.

The first linking end 15 on the first page 10 is permanently attached to the second linking end 25 of the second page 20. “Permanent attachment” here means that detachment will cause physical damages to the pages. The first page 10 and the second page 20 are overlapping without attachment, concealing the inner sides of the pages. Alternatively, the first connecting end 18 of the first page 10 may be removably attached to the second connecting end 28 of the second page 20. Here “removable attachment” means detaching the first connecting end 18 from the second connecting end 28 will not cause physical damage to the first page 10 and second page 20. As indicated above, attaching the first connecting end 18 to the second connect end 28 is not a strict requirement. When the two pages are overlapping, the device is in a “closed” form. The removable attachment (if exists) of the connecting ends may be achieved by any means feasible. For example, the first connecting end 18 may be connected to the second connecting end 28 by an easily breakable paper strip. Alternatively, the two connecting ends may be attached by small magnets or hook-and-loop structures. As long as the connections are breakable without damaging the pages, the means of attachment is acceptable.

It is preferred that the stimulating factors—images, words, odors—are concealed by the addiction cessation device before the device is being used, thus preventing un-targeted stimulations to the user of the device. As indicated above, the addiction cessation device may take the form of a note or other structures such as a handheld computing device. When the device is a note, as shown in a preferred embodiment in FIG. 1, the two page design is not the only option. However, two-page or multi-page designs are preferred because such designs provide a basic concealing mechanism by overlapping the pages. One-page design, nevertheless, is still possible if the stimulating factors are concealed by other structures.

The pages may be made from any material that may form thin sheets, such as but not limited to page, plastics, and foil. The preferred material is paper. The device can be any size. The length and width of the pages may range from 0.5-50 inches (1.27-127 cm), with the preferred range of 1-10 inches (2.54-25.4 cm). It is preferred that the devices are light, small, easily portable, and do not occupy too much space even if many devices are carried by the user.

The first page outer side 11, which is exposed even when the device is in a “closed” form, may be blank or have images and/or words 100 printed thereon. Generally, it is preferred that these images and/or words 100 create positive reactions, instead of negative ones. The images and/or words 100 may be used to encourage the user to quit smoking. Or the images and/or words 100 may be used to urge the user to open the device whenever the urge to smoke arises. In FIG. 1, the images and/or words 100 are a sentence aiming at encouraging the user to use the device.

FIG. 2 shows a perspective view of the embodiment an addiction cessation device of FIG. 1 in an open form. In the “open” form, the first page 10 and second page 20 are not overlapping and the images and words in the inner sides of the device are exposed. Shown in FIG. 2 is the addiction cessation device 1 having a first page 10 and a second page 20 and the two pages overlap. The first page 10 has a first page outer side 11 (not shown in FIG. 2), a first page inner side 12, a first linking end 15, and a first connecting end 18. The second page 20 has a second page outer side 22 (not shown in FIG. 2), a second page inner side 21, a second linking end 25, and a second connecting end 28.

Printed on the first page inner side 11 and second page inner side 21 are images 30 and words 40. As indicated above, the images 30 and words 40 are designed to create negative reactions in the user. Also as indicated above, “negative reactions” are broadly defined. The images 30 may be any kind of pictures, photos, drawings, or illustrations. The words 40 may be any kind of descriptions, slogans, sentences, and paragraphs. As long as the goal of creating negative reaction is achieved, any images and words may be used. For example, the images 30 may be pictures of cancerous lung tissues or other tissues. The words 40 may be descriptions of the image 30, statements regarding the negative impact of smoking to one's health, or statistics regarding smoking-related fatalities, or any combinations thereof.

It should also be noted that the arrangement of images 30 and words 40 can vary significantly. There may be only images or only words, though the combination of images and words is preferred. The images may be on the second page inner side 21, instead of the first page inner side 11. The words may be on the first page inner side 11, instead of the second page inner side 21. The images and words may also mix up to enhance the visual and psychological impact. The central goal is to create negative reactions. As long as this goal may be achieved, any kind of images and words and any arrangement may be chosen.

Other mechanisms may also be employed to strengthen the negative reactions of the user of the addiction cessation device. For example, an odor-releasing mechanism may be used. When the first page 10 and the second page 20 are overlapping, the odor-releasing mechanism is not triggered. To achieve such a goal, the odor-releasing mechanism may be a tiny vial sealed by the polymer sticking points located on the first page 10 and second page 20. Lifting the first page 10 from the second page 20 breaks the vial and releases the odor. Alternatively, the odor-releasing mechanism may involve chemicals sealed in tiny pouch of plastic wraps. Detaching the first page 10 from the second page 20 may break the pouch and allow the chemical to release the odor. The odor releasing mechanism may also involve chemicals encapsulated or incorporated in an adhesive used to hold the first page 10 and second pager 20 together. When opened, the micro bubbles in the adhesive releases the odiferous compounds. The odor may be any general foul smell, or it may be any specific odor associated with diseases or tissues resulted from the addiction.

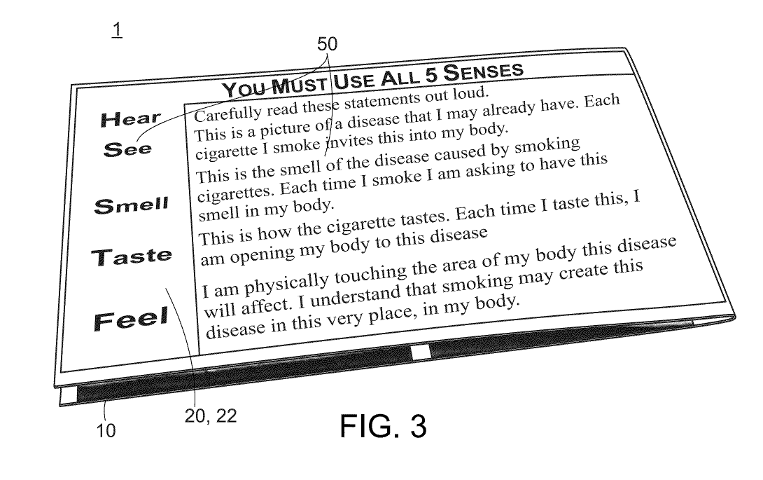

FIG. 3 shows a back perspective view of the embodiment of an addiction cessation device of FIG. 1 in a closed form. Shown in FIG. 3 is the addiction cessation device 1 having a first page 10 and a second page 20 and the two pages overlap. The second page 20 has a second page outer side 22 and a second page inner side 21 (not shown in FIG. 2).

The second page outer side 22 may be blank or may contain some words or images. Supposedly, the second page outer side 22 will be viewed by the user after the exposure to the inner sides of the first and second pages. The preferred passage 100 is printed on the second page outer side 22 as shown in FIG. 3. This passage 100 links the stimulating factors, the negative reactions generated by the images 30 and words 40 in the inside of the device, to the addiction itself.

The passage 100 serves to associate the negative reactions to the addiction, re-enforcing the notion that quitting the addiction is the best way out. The passage 100 goes through the five senses and links each one with the negative reaction and the physical impact of smoking. Nevertheless, it should also be noted that such association of the stimulating factors, the negative reactions, and the addiction may be achieved by other words or images, replacing the passage 100 shown in FIG. 3.

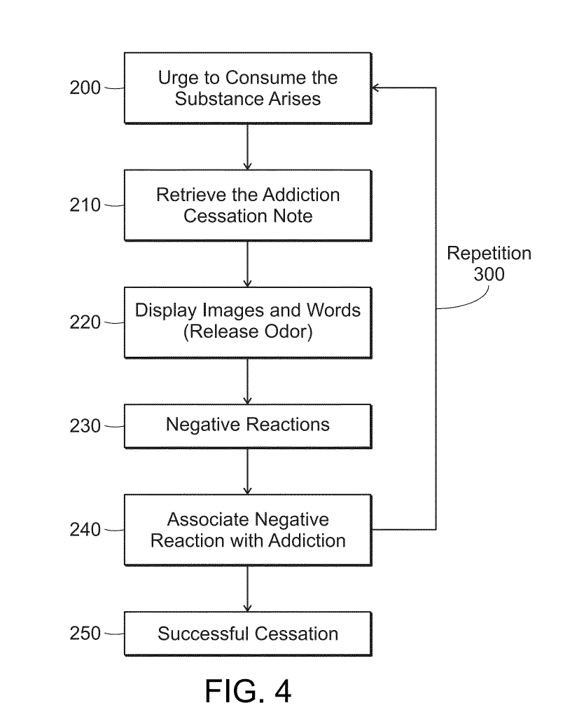

FIG. 4 shows an addiction cessation method in a flow chart. The general steps are: whenever the urge to consume the substance arises 200, retrieve the addiction cessation device 210, open the device to trigger the stimulating factors—display the images and words, release the odor 220, produce the negative reactions 230, and associate the negative reactions to the addiction 240. By repetition 300 of the processes 200-240, successful cessation may be achieved 250. One key to the current invention is to repeat the process of using the addiction cessation device. Only with repetition can the association between negative reactions and the addiction be established and stabilized.

As indicated above, the addiction cessation method is closely related to the addiction cessation device. Using the device properly is central to the success of the method. The device is supposed to be used to provide stimulation to the user whenever the urge to consume the abused substance arises. When the device is a note, as shown in FIGS. 1-3, the first page outer side 11 may supposedly be viewed any time, but particularly before the impulse intensified. The images 30 and words 40 on the inner sides are revealed to the user to create negative reactions. Whether the user proceed to consume the substance is not crucial as long as repetitive exposure to the stimulating factors reduced the psychological and physical appeal of the substance. The second page outer side 22 may supposedly be viewed by the user after the showing of the inner sides and it may help to strengthen the association between the negative reaction and the addiction. Repetitive exposure, preferably with devices having different contents, will significantly enhance the chance of successful cessation. When the device is a mobile digital apparatus, the user may simply turn on the device and activate the program designed to present the stimulating factors that may create negative reactions. An association of the negative reactions and the abused substance may also be created with repeated use of the handheld apparatus.

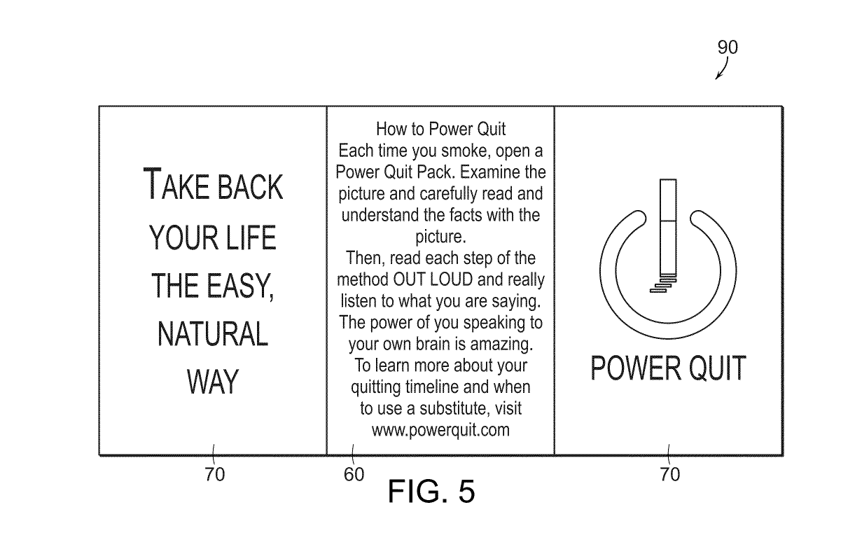

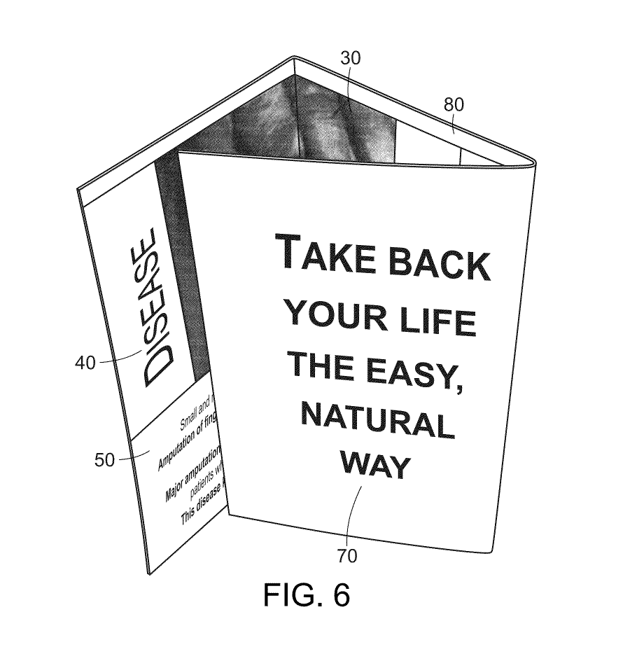

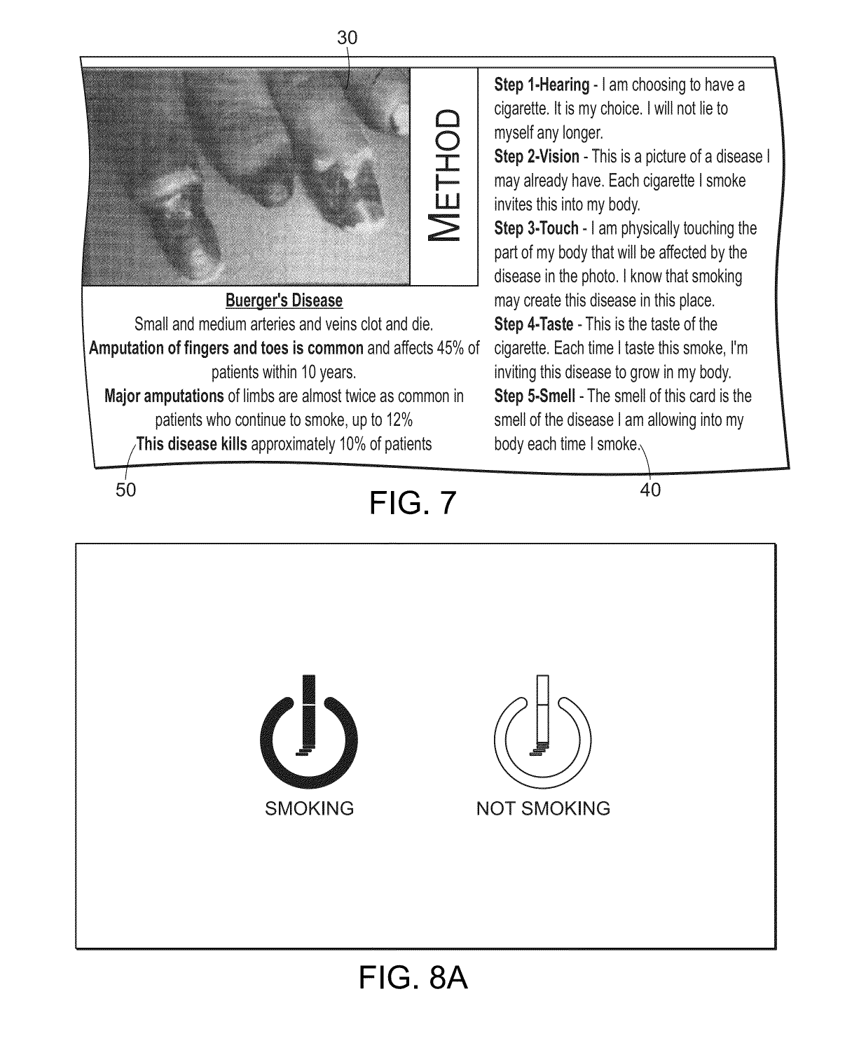

FIGS. 5, 6 and 7 illustrate another preferred embodiment where the device is a trifold. The device has a flat surface 90 which has a front side 50 and a back side 60. The device is folded into three substantially equally sized parts, two of which make two cover pages 70 that can be folded so as to conceal the images 30 and words 40 that are printed in the front side 50 of the trifold. The front side may also include an adhesive strip 80 that is impregnated with micro burst oil pubbles which will release addiction related odors upon unfolding the trifold. According to one preferred embodiment the oil pubbles comprise a blend of putrasene and cadaverene. The adhesive strip may locate anywhere on the front side 50 as long as it is concealed when the trifold is folded.

The device may also be folded in four parts or in any preferred number.

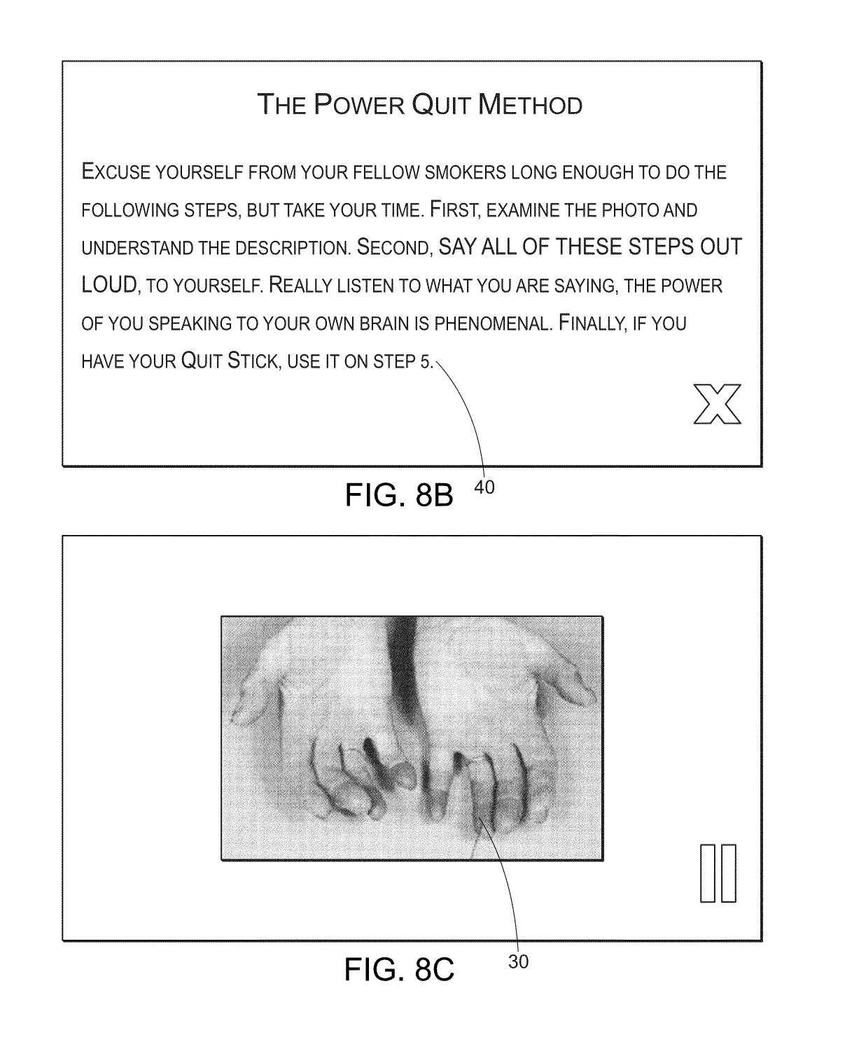

FIG. 8 shows smart phone or tabloid application of the device. The words 40 and images 30 may be revealed on separate screens.

Another aspect of the current invention is that the device and method may be used for not only smoking, but also other addictions such as alcohol abuse, food addiction, and pain killer abuse. The stimulating factors may be adjusted according to the particular cessation goal at hand. For example, to assist quitting alcohol abuse, the images and words in the inner sides of the pages may deliver the message that continued and large volume alcohol consumption causes large number of deaths and severe health problems. The images may be scenes of traffic accidents caused by drunk driving or tissues of an alcohol ravaged stomach. The words may be statistics of alcohol related fatalities or description of alcohol related disease. When the current device is used to combat food addiction, the device may bear the images of diseased tissues related to over-consumption of food and words regarding negative impact of the food addiction. In general, the adjustment of the images and words may help the user to quit the particular addiction he/she is fighting against.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An addiction cessation device to assist quitting an addiction, said device comprising:
a flat surface having a back side and a front side, said flat surface being folded so that the back side forms at least one cover page to conceal the front side, and wherein the front side comprises words and images that cause negative reactions to the addiction and the words and images on the front side can be revealed by unfolding the flat surface.

2. The device of claim 1, wherein the front side additionally includes an adhesive strip impregnated with micro burst oil bubbles that are released upon unfolding the flat surface.

3. The device of claim 2, wherein the oil bubbles comprise a blend of putrasene and cadaverene.

4. The device of claim 1, wherein the backside comprises a passage associating the addiction with the negative reactions created by the images and the words on the front side.

5. The device of claim 4, wherein the device is folded at its middle, thereby forming a two page format.

6. The device of claim 4, wherein the device is a trifold.

7. The addiction cessation device of claim 1, wherein
the addiction is smoking and the images are related to adverse effects of smoking.

8. The addiction cessation device of claim 1, wherein the device is made of paper, cardboard, or plastic.

9. An addiction cessation device to assist quitting an addiction, comprising:
a first page having a first page inner side and a first page outer side,
and a second page having a second page inner side and second page outer side, wherein
the first page and second page are linked,
the first page inner side bearing images or words that cause negative reactions to the addiction,
and the second page inner side bearing images or words that cause negative reactions to the addiction.

10. The addiction cessation device of claim 9, wherein
the first page has a first linking end permanently attached to a second linking end of the second page,
the first page is overlapping with the second page,
overlapping the first page with the second page conceals the first page inner side and the second page inner side,
and lifting the first page from the second page displays the images and words on the first page inner side and the second page inner side.

11. The addiction cessation device of claim 9, wherein
the addiction is smoking,
the first page inner side bears anti-smoking images or words,
and the second page inner side bears anti-smoking images or words.

12. The addiction cessation device of claim 9, wherein
there is a passage printed on the second page outer side associating smoking with the negative reactions created by the images and words on the first page and second page.

13. An addiction cessation method to assist quitting an addiction to a substance by a user, said method comprising:
retrieving an addiction cessation device of claim 1 each time the user has an urge to consume the substance;
revealing the images and words on the addiction cessation device to the user to create negative reactions to the addiction to the substance;
and providing information to associate the images and words to the addiction.

14. The addiction cessation method of claim 13, wherein
the addiction is smoking or alcohol abuse.

15. The addiction cessation method of claim 13, further comprising
releasing an odor from the addiction cessation device to create a negative reaction in the user regarding the substance of the addiction.

16. The addiction cessation method of claim 15, wherein the odor is released by unfolding the device.

17. An addiction cessation method to assist quitting an addiction to a substance by a user, comprising:
retrieving an addiction cessation device of claim 9 each time the user has an urge to consume the substance, wherein
the device having a first page and a second page with images and words printed on the first page and the second page,
the first page and the second page overlapping to conceal the images and words;
revealing the images and words on the addiction cessation device by lifting the first page from the second page;
displaying to the user the images and words to create negative reactions to the addiction to the substance;
releasing an odor from the addiction cessation device to create negative reactions to the addiction to the substance;
and providing information of associating the images, words, and the odor to the substance.

18. The addiction cessation method of claim 17, wherein
the odor is released by lifting the first page from the second page.

19. The addiction cessation method of claim 18, wherein
the addiction is smoking and the substance is tobacco or the addiction is alcohol abuse and the substance is alcohol.
